(19) United States
(12) Patent Application Publication
(10) Pub. No.: US 2024/0132254 A1
(43) Pub. Date: Apr. 25, 2024

(54) HAIR COLOR CONTAINER WITH MIXING FEATURES

(71) Applicant: Kiss Nail Products, Inc., Port Washington, NY (US)

(72) Inventors: Sung An Chae, Levittown, NY (US); Sang Hun Yoo, Port Washington, NY (US)

(21) Appl. No.: 18/546,395

(22) PCT Filed: Feb. 23, 2022
(86) PCT No.: PCT/US22/17587

§ 371 Date: Aug. 13, 2023

Related U.S. Application Data
(60) Provisional application No. 63/152,722, filed on Feb. 23, 2021.

(51) Int. Cl. B65D 35/24; A45D 34/04; B01F 25/431; B01F 25/4314; B65B 3/00; B65B 5/04; B65B 5/06; B65B 7/14; B65B 61/26; B65D 35/22; B65D 35/38; B65D 35/44; B65D 77/06

(52) U.S. Cl. CPC B65D 35/242; A45D 34/04; B01F 25/43141; B01F 25/4316; B65B 3/00; B65B 5/04; B65B 5/06; B65B 7/14; B65B 61/26; B65D 35/22; B65D 35/38; B65D 35/44; B65D 77/06; A45D 2200/058; B01F 2101/30; B65B 2220/16; B65D 2217/02

(57) ABSTRACT

A container with multi-chambers is described. Each hair coloring substance of the multi-chamber is stored in its sub-chamber. The final hair coloring solution is formed by mixing the hair coloring substances in mixing sub-chambers in liquid communication with the interior of each of the sub-chambers. An optional mixing nozzle is also used in conjunction with the mixing chamber, and the mixing nozzle may include a helical mixing tool.

This application claims priority to U.S. provisional application 63/152,722, filed on Feb. 23, 2021, presently pending, the contents of which are incorporated by reference.

### BACKGROUND OF THE INVENTION

### 1. Field of the Invention

The field of the invention is a multi-chamber container for hair coloring substances with a nozzle facilitating mixing the contents of the container to create a hair coloring solution. In one embodiment, the container comprises a tube with a nozzle, facilitating the mixing of the container's contents, including a developer and a colorant.

### 2. Background of the Invention

Many hair coloring products require mixing two or more hair coloring substances to create a hair coloring solution before use by the end customer. For many years, such products would be sold in separate containers, where each container contains a hair coloring substance to be mixed with additional substance(s) from other container(s). The customer would have to extract each container's content and then mix it with the content(s) from any other container(s) manually to create the hair coloring solution to apply to the customer's hair.

Hair coloring solution generally has two substances: a developer and a colorant. The developer allows the color to penetrate the cuticle by activating the colorant. However, as the developer includes hydrogen peroxide and other chemicals that degrade in time, the developer should not interact with the colorant until actual application.

A standard solution to this problem is to place each hair coloring substance in a separate container, and the end-user would mix the hair coloring substances in a third container. However, this procedure involves multiple containers and creates waste. It also forces the end-user to mix the two hair coloring substances by hand. It also increases the possibility that the hair coloring substances and the final hair coloring solution will spill and stain the work area.

A need exists in the art for a single-piece dispenser of hair coloring solution that includes a mixing feature that does not require user intervention. A need also exists for a method of manufacturing such a dispenser for a hair coloring solution.

### SUMMARY OF INVENTION

An object of the invention is to create a multi-chamber container for hair coloring substances that overcomes drawbacks in the prior art. A feature of the invention is that the container includes multi-chambers (two or more) that hold different hair coloring substances with a mixing nozzle in communication with the sub-chambers. An advantage of the invention is that the hair coloring substances in the sub-chambers are not mixed until needed by the end-user. An additional advantage of the invention is that the end-user can mix the amount of hair coloring substances desired at the time.

A further object of the invention is to provide a container that dispenses an already mixed hair coloring solution. A feature of the invention is that the container's mixing nozzle mixes hair coloring substances thoroughly, and additional mixing is not required. An advantage of the invention is that the end-user does not need to perform additional product preparation steps after dispensing.

Another object of the invention is to create a container that holds multiple hair coloring substances in separated segments until dispensing. A feature of the invention is that, in one embodiment, the container includes multi-chambers that hold hair coloring substances separated from one another until the hair coloring substances are mixed. An advantage of the invention is that the hair coloring substances do not react until the end-user mixes the hair coloring substances.

Yet another object of the invention is to provide a container that mixes hair coloring substances without requiring an external mixing container. A feature of the invention is that the mixing occurs as the hair coloring substances leave the container without requiring a separate mixing container or cup. An advantage of the invention is that the container eliminates the need for an external mixing cup, decreasing waste generated during dispensing.

Another object of the invention is to provide a dispenser where correct quantities of hair coloring substances are dispensed for mixing. A feature of the invention is that the container includes a mixing nozzle, which controls each hair coloring substances' amount entering the mixing area. A benefit of the invention is that it can support multiple different types of finished hair coloring solutions.

Another object of the invention is to provide a convenient system. A feature of the invention is that all hair coloring substances are kept together in a single container during dispensing. An advantage of the invention is that all hair coloring substances for mixing are kept in one main body.

The invention provides a multi-chamber container having a main body with at least two sub-chambers separated from each other, except at an exit area, which includes a mixing nozzle that has a mixing structure.

Also provided is a manufacturing method for a multi-chamber container comprising joining two sub-chambers in one main body with a nozzle in communication with both sub-chambers. A nozzle with a mixing structure is also manufactured.

### BRIEF DESCRIPTION OF THE DRAWINGS

The invention, together with the above and other objects and advantages, will be best understood from the following detailed description of the preferred embodiment of the invention shown in the accompanying drawings, wherein:

FIGS. 1A and 1B depict an overview of one embodiment of the container;

FIG. 2A depicts a close-up view of the mixing area of one embodiment of the container;

FIGS. 2B-C depict details views of covers for one-way covers, in one embodiment of the container;

FIG. 3 depicts a schematic view of a nozzle which can be used in conjunction with one embodiment of the invention;

FIG. 4 depicts an embodiment of the invention with the removable nozzle attached;

FIG. 5 depicts a flow chart of the manufacturing of one embodiment of the container;

FIGS. 6A and 6B depict an overview of an alternative embodiment;

FIGS. 7A-C depict a detailed view of one component of an alternative embodiment;

FIGS. 8A-C depict a detailed view of another component of an alternative embodiment;

FIG. 9 depicts detailed views of several components of an alternative embodiment; and

FIGS. 10A-G depict detailed views of a component of an alternative embodiment.

### DETAILED DESCRIPTION OF THE INVENTION

The above summary and the following detailed description of specific embodiments of the present invention will be better understood when read in conjunction with the appended drawings.

As used herein, an element or step recited in the singular and proceeded with the word “a” or “an” should be understood as not excluding plural said elements or steps unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

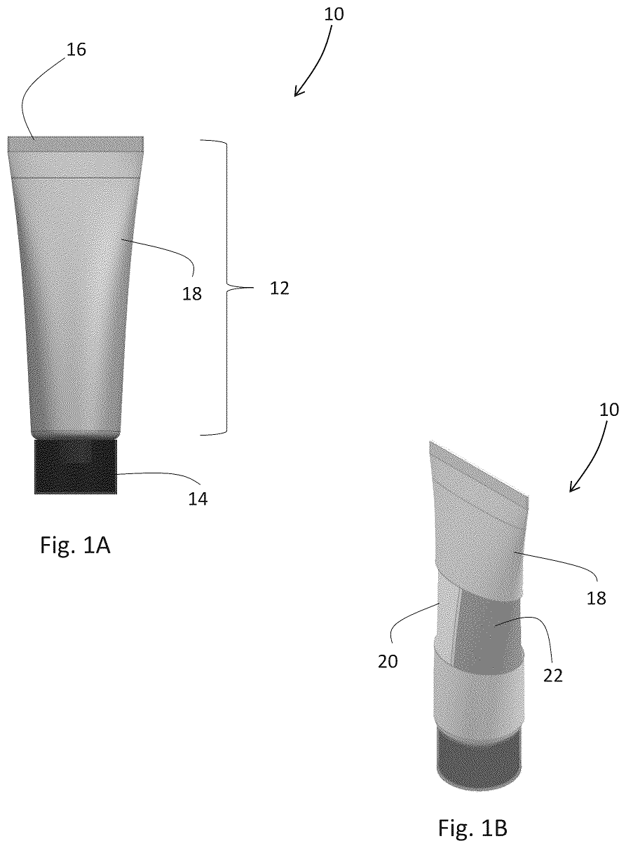

Turning to the figures, FIG. 1A depicts an overview of the hair coloring substance storage device or container 10 having a main body 12 and a cap 14. In some embodiments, the cap 14 is removable, in other embodiments, a hingeable portion of the cap 14 opens to provide access to the interior of the container 10, and the cap 14 is not removable. While the cap 14 is shown as a separate element in FIG. 1A, in some embodiments, the cap 14 is integrally molded into the main body 12. The main body 12 has a conventional tapered shape with a cinch seal closure 16. The main body 12 includes an outer covering 18. In one embodiment, lot and production information is added to the seal closure 16 area at the manufacturing time (not shown). The outer covering 18 is made from a compressible plastic material in one embodiment. Further, the outer covering 18 is designed to accept ink or an ink-bearing film so that product identifying information can be printed directly on the outer covering 18. The information forms printed indicia on the outer covering 18, in this embodiment, and can include information such as expiration date and the lot number discussed above. However, the container 10 may be of any appropriate shape, design, and size that can hold two or more hair coloring substances in separate chambers from each other.

A benefit of the invention is that the overall container 10 has a conventional shape while including a number of novel features optimized for dispensing hair coloring solutions. As such, an end-user will be familiar with the container 10 even though the container 10 includes novel features.

In the depicted embodiment, the cap 14 includes a flat area that allows the container 10 to stand on the cap 14.

In some embodiments, the cap 14 includes a storage area for an optional mixing nozzle, which will be described in detail below.

In some embodiments, the outer covering 18 includes a side window (not shown) to allow the end-user to see how much hair coloring substance remains in the main body 12.

FIG. 1B shows a partial cut-away view of the container 10. In the view shown in FIG. 1B, part of the outer layer of the outer covering 18 of the main body 12 is removed, showing the internal structure of the main body 12. The main body 12 contains two sub-chambers 20, 22. Each sub-chamber 20, 22 is covered by the outer covering, and each spans half of the main body 12, in the depicted embodiment. In other embodiments, the two sub-chambers 20, 22 are not of equal volume, with one containing a larger quantity of hair coloring substance than the other. The embodiment 10 shown in FIG. 1B is adapted for use to dispense a multi-part hair coloring substances with a first substance (e.g., colorant) in the first sub-chamber 20 and the second substance (e.g., developer) in the second sub-chamber 22.

In the embodiment shown in FIGS. 1A and 1B, the outer covering 18 is shown as being substantially opaque. In other embodiments, the outer covering 18 is at least partially transparent so that it is possible to observe the contents of the two sub-chambers 20, 22. In still other embodiments, the outer covering 18 is translucent so that the contents of the two sub-chambers 20, 22 can be observed when the container 10 is placed against a light source.

The main body 12 outer layer comprises a flexible plastic such as high-density polyethylene, in one embodiment. In other embodiments, the main body 12 and the two sub-chambers 20, 22 use a combination of HDPE and low-density polyethylene plastics. In one embodiment, the outer layer uses LDPE, and the two sub-chambers 20, 22 use HDPE. In some embodiments, the cap 14 and the add-on mixing nozzle comprise a different material, such as polypropylene.

The embodiment of the hair coloring container 10 shown in FIGS. 1A and 1B is particularly adapted to dispensing of a hair coloring dye (colorant) and a developer. As discussed above, the two sub-chambers 20, 22 need not be of equal volume. In an embodiment, the volumes of the two sub-chambers 20, 22 are customized to facilitate the mixing of hair coloring substances having ratios other than one-to-one, as can be required for some hair coloring substances.

The invention allows for the mixing of two or more fluid hair coloring substances to create a hair coloring solution to be applied to a user's hair. Each fluid substance may be a neat liquid, a fluid phase material, a fluid mixture, an aqueous solution, a colloidal dispersion, an emulsion, and combinations thereof.

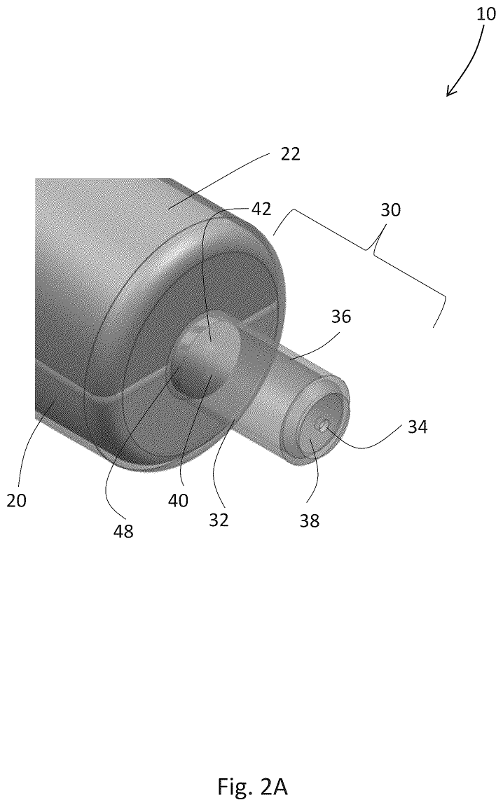

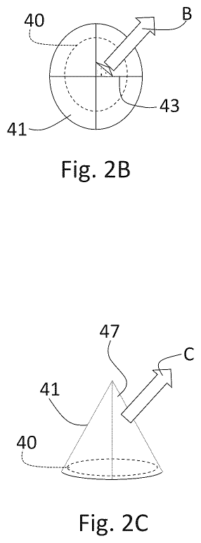

FIG. 2A depicts the details of the mixing nozzle area 30 of the container 10. The nozzle 32 includes a mixing chamber 36 and an exit port 34 on the output side 38 of the mixing chamber 36. In the depicted embodiment, the mixing chamber 36 is approximately one to two inches high so that the mixing nozzle area 30 can fit in the cap 14 shown in FIGS. 1A and 1B.

While the nozzle 32 is shown as having a smooth outer surface in FIG. 2A, the nozzle 32 outer body includes threads in some embodiments. Corresponding threads are used to removably attach the cap 14 shown in FIG. 1A to the nozzle 32, or the mixing nozzle add-on described fully below.

The mixing chamber 36 is made from partially transparent plastic in one embodiment. In one embodiment, the mixing chamber 36 is substantially hollow. In other embodiments, the mixing chamber 36 includes structures to assist in the mixing of the hair coloring substances. As shown in FIG. 2A, the mixing chamber 36 is substantially cylindrical in some embodiments.

The side 48 facing the main body 12 includes ports 40, 42, which are in fluid communication with the two sub-chambers 20, 22, respectively.

While the ports 40, 42 are depicted as equally sized in FIG. 2A, in some embodiments, each port 40, 42 is of a different size. While FIG. 2A shows the ports as being open to the mixing chamber 36, in some embodiments, additional covers are added on the ports, such as those shown in FIGS. 2B and 2C.

In FIG. 2B, each port, such as the port 40 depicted in FIG. 2B, is covered by a cover 41 having one or more slits 43 which fold out in the direction indicated by arrow B when pressure is applied into the corresponding sub-chamber. The cover 41 returns to its original form, substantially closing the port 40. FIG. 2C shows another embodiment of the cover 41 over the port 40. The cover 41 is substantially conical or triangular. Flaps 47 of the cover 41 open outwards, in the direction shown by arrow C when a substance exits the port 40.

The covers, such as covers 41 shown in FIGS. 2B, 2C facilitates intermittent dispensing of the hair coloring substances, allowing the overall device to be used intermittently. The hair coloring substances of the sub-chambers will not continue mixing unless explicit pressure is applied to breach the cover 41. Further, the hair coloring substances will not contaminate one another if the end-user pauses use. The cover 41 with slits 43 or flaps 47 prevent bi-directional movement of fluid through the port 40. Therefore, the hair coloring substances of the main body can exit, but the structures make it difficult for the hair coloring substances to return to the main body.

A benefit of the mixing nozzle and ports with variable flow rates is that hair coloring substances having varying viscosities can still be mixed, maintaining a required ratio. For example, for most hair colors, the colorant and developer should be mixed in a one-to-one ratio, but the colorant is thicker. For such a product, the opening of the developer sub-chamber is smaller or has a stronger cover to allow for variable mixing.

As the container 10 is squeezed, pressure on the first sub-chamber 20 causes its hair coloring substance to exit through the port 40. Similarly, pressure on the second sub-chamber 22 causes its hair coloring substance to exit through the port 42.

In one embodiment, as shown in FIG. 1A, the outer covering 18 ensures that any pressure applied to the container 10 is distributed to both sub-chambers 20, 22 in a substantially equal manner. The outer covering 18 or the covering substrate acts as a pressure-equalizing reversibly deformable material in this embodiment.

The small size of the exit port 34 is designed to ensure that the hair coloring substances exiting through the ports 40, 42 spend sufficient time in mixing chamber 36 before exiting mixing chamber 36. In the embodiment shown in FIG. 2A, the exit port 34 is only 5% of the surface area of the output side 38 of the mixing chamber 36. The small size of the exit port 34 results in turbulence in the flow of the hair coloring substances from the two sub-chambers 20, 22, assisting in mixing the hair coloring substances.

The mixing of the hair coloring substances is also facilitated by the hair coloring substances being combined. In one embodiment, the two hair coloring substances are compatible, given similar densities and suitable chemical substances. For hair coloring solution, the hair coloring substances may be a corresponding hair coloring dye (colorant) and a corresponding developer.

In one embodiment, the cap 14 shown in FIG. 1A includes a prong to cover the exit port 34 and to ensure that the mixing chamber 36 does not dry out while the container 10 is not in use. The prong also helps to keep the cap 14 aligned with the mixing nozzle area 30.

In one embodiment, the ports 40, 42 must be opened before first use. In one embodiment, the ports 40, 42 are covered by a metallic substrate when the two sub-chambers 20, 22 are filled. Before first use, the mixing chamber 36 must be temporarily removed and the metallic substrate removed. In other embodiments, the ports 40, 42 are covered by a plug that can be breached with a sharp instrument, such as a needle. In this embodiment, the plugs on the ports 40, 42 are much softer than the material comprising the remainder of the side 48 facing the main body 12. In one embodiment, the cap 14 includes an integrated breaching implement, such as a sharpened tool.

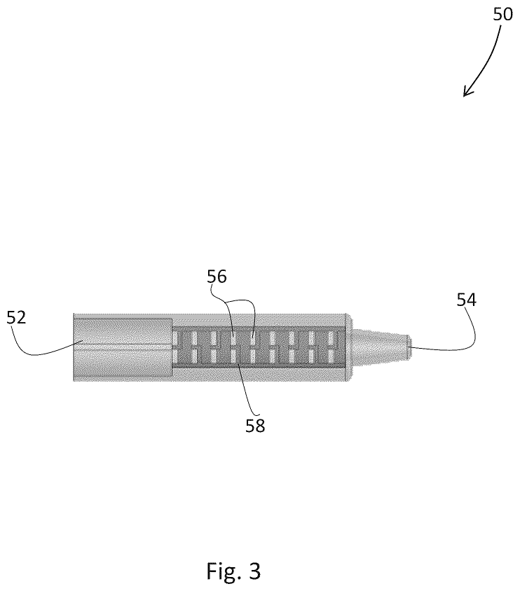

FIG. 3 depicts an optional mixing nozzle 50. The optional mixing nozzle 50 has an input side 52 and an output side 54. The interior of the optional mixing nozzle 50 is shown in the partial cut-away view of FIG. 3. The interior of the optional mixing nozzle 50 comprises several linear 56 and hook-shaped 58 internal structures. The interior of the optional mixing nozzle 50 structures comprises mixing nozzle structures. The hook-shaped 58 structures form walls that join at 90-degree angles in some embodiments. The interior of the optional mixing nozzle 50 includes structures that ensure that the fluid passing through the optional mixing nozzle 50 flows along a winding path and continues to mix as it traverses the interior of the optional mixing nozzle 50.

The several linear 56 structures ensure that the liquid undergoing the hair coloring substances does not flow too quickly through the optional mixing nozzle 50. The several linear 56 structures control the velocity of flow of hair coloring substances out of the optional mixing nozzle 50. In one embodiment, any interior features, such as the several linear 56 structures or other mixing nozzle features described herein, act to decrease the velocity of liquid flow through the nozzle. Additionally, the hook-shaped 58 structures ensure that the hair coloring substances' flow is not straight but rather turns and therefore increases the mixing time-nearly every point of contact between the hair coloring substances and the hook-shaped structure results in a local vortex. The flow of the hair coloring substances is disturbed in this manner to encourage the mixing of the hair coloring substances.

The embodiments shown in the figures depict linear structures; other shapes are used for the mixing nozzle in other embodiments (not shown). For example, in one embodiment, the mixing nozzle is substantially oval or round so as to follow the general shape of the cap 14 shown in FIG. 1A. In one embodiment, such a mixing nozzle is initially attached to the cap 14 so that the embodiment is sold as a single piece. The mixing nozzle in this configuration still includes an input side and an output side, but the internal shape is more circular.

As shown in FIG. 3, the several linear 56 structures and the hook-shaped 58 structures have various thicknesses in one embodiment. In other embodiment, the structures have a substantially equal thickness.

In some embodiments, the several linear 56 structures and the hook-shaped 58 structures are molded integrally to the interior of the optional mixing nozzle 50. In other embodiments, they are added to the optional mixing nozzle 50 as an insert during the manufacturing of the optional mixing nozzle 50.

In another embodiment, not shown, the mixing chamber features spiral grooves or rifling.

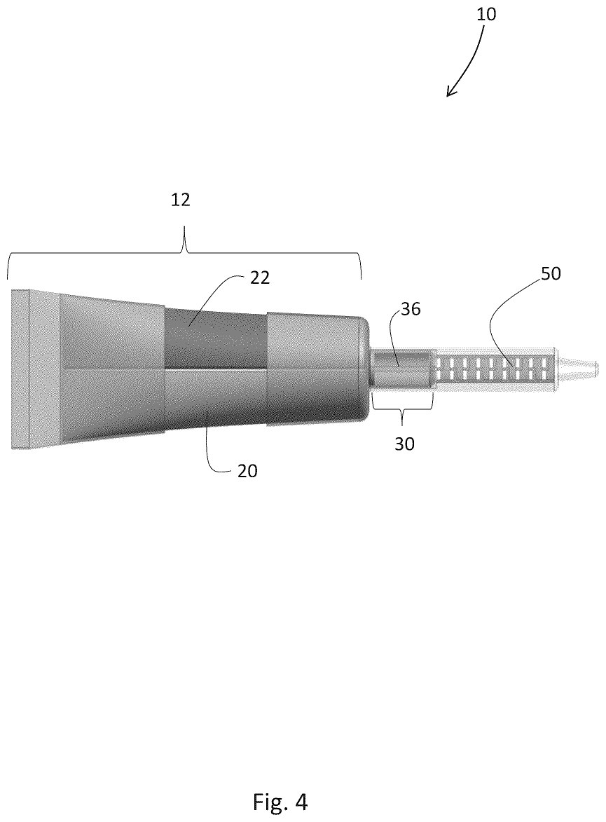

The optional mixing nozzle 50 is used in conjunction with the mixing chamber 36 shown in FIG. 2A. As shown in FIG. 4, in use, the optional mixing nozzle 50 is installed over the mixing chamber 36 that forms part of the mixing nozzle area 30. Any solution exiting a sub-chamber (or sub-chambers) must pass through the optional mixing nozzle 50 before leaving the container 10.

As shown in FIG. 4, the mixing nozzle area 30 becomes the location of the initial mixing of the hair coloring substances of the two sub-chambers 20, 22. Additional mixing occurs in the optional mixing nozzle 50.

The optional mixing nozzle 50 is attached to the mixing chamber 36 using frictional engagement in one embodiment. It is critical that the optional mixing nozzle 50 remain in place during use and during the mixing processes. In some embodiments, the optional mixing nozzle 50 includes additional means to attach the optional mixing nozzle 50 to the mixing chamber 36. For example, in one embodiment not shown, the mixing chamber includes a post, and the optional mixing nozzle has a corresponding aperture, forming a bayonet mount. In another embodiment, the optional mixing nozzle and the mixing chamber feature corresponding screw fittings.

As shown in FIGS. 3 and 4, the optional mixing nozzle 50 has several physical features that are particularly advantageous to the mixing of the hair coloring substances of the two sub-chambers 20, 22. The internal structures of the optional mixing nozzle 50 ensure that the hair coloring substances passing through the optional mixing nozzle 50 do not flow in a laminar flow. Instead, the flow is designed to be turbulent with discrete eddies and vortices caused by the specific topography of the interior of the optional mixing nozzle 50.

In at least one embodiment, the optional mixing nozzle 50 includes features that reversibly deform depending on the flowing liquid's pressure. In this embodiment, the amount of turbulence in the flow changes depending on how hard the end-user presses on the outside of the container 10. If the end-user exerts a high amount of pressure, the features are pushed up, creating more turbulence within the optional mixing nozzle 50.

In another embodiment, the structures within the optional mixing nozzle 50 are designed to cause friction when the hair coloring substances flow over the structures. In this embodiment, the structures include an external surface with dimples, ridges, and other surface features to ensure that the hair coloring substances' eddies are created when the hair coloring substances pass over the optional mixing nozzles 50.

In the embodiment shown in FIGS. 3 and 4, the number of 90-degree angles and other sharp angles within the optional mixing nozzle 50 is maximized. In the embodiment shown in FIG. 3, a hair coloring substance starting at the input side 52 will need to make at least eight ninety-degree turns (or nearly ninety-degree turns) as it flows towards the output side 54.

In one embodiment, the optional mixing nozzle 50 is made from a transparent material so that the end-user can observe the process of the hair coloring substances' flow traversing the optional mixing nozzle 50. In another embodiment, the optional mixing nozzle 50 is only partially transparent.

As the optional mixing nozzle 50 is used to mix hair coloring substances with a dye, the color of the final hair coloring solution will change as the mixing continues. Therefore, the end-user can use the transparent or partially transparent optional mixing nozzle 50 to ensure that the mixing is occurring to an acceptable degree. If the mixing is not sufficient, the end-user will know to apply less pressure to the container 10.

FIG. 4 shows the optional mixing nozzle 50 installed on the mixing nozzle area 30 of the main body 12. In some embodiments, in order to save shipping space, the optional mixing nozzle 50 is initially stowed in an indentation in the flexible main body 12 (not shown). In another embodiment, the optional mixing nozzle 50 is removably attached to the main body 12 by being placed next to the main body 12, and then shrink wrap encapsulates the optional mixing nozzle 50 and main body 12. In this embodiment, a perforation and printed indicia are added to the shrink wrap to assist in removing the optional mixing nozzle from the main body. In this embodiment, the shrink wrap also acts as a tamper-evident device by providing another seal around the hair coloring product's main body 12. The shrink wrap provides another layer of sealing that seals hair coloring solution that could react with the ambient atmosphere and should otherwise be kept in an isolated environment.

In at least one embodiment, the main body 12 also includes at least one area of partial or complete transparency (not shown). This allows the end-user to gauge the amount of hair coloring substances left remaining in at least one chamber. In some embodiments, where the mixing from the sub-chambers occurs equally or nearly equally, only one such area of transparency is required. In other embodiments, each side corresponding to a different two sub-chamber 20, 22 includes such an area indicating the hair coloring substances' level remaining in that two sub-chamber 20, 22.

### Manufacturing Overview

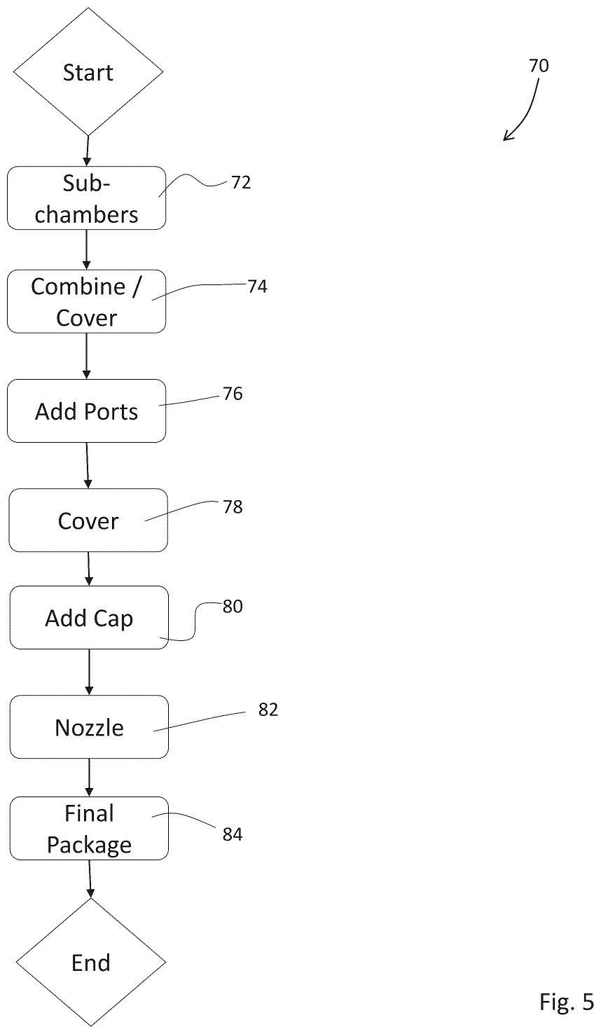

An overview of the manufacturing process 70 is shown in the flowchart in FIG. 5.

The process begins by selecting the contents of each of the sub-chambers and forming the sub-chambers 72. In one embodiment, the sub-chamber formation is performed with a conventional bladder forming step.

Next, the sub-chambers are attached and covered 74 with an outer or external cover. In one embodiment, this outer cover comprises an outer covering that is pre-printed with product information.

Subsequently, the ports are added 76, ensuring that the sub-chambers are in hair coloring substances communication with a mixing chamber. However, to prevent the hair coloring substances of the sub-chambers from drying out, the ports are covered 78 as part of the manufacturing process 70.

The mixing chamber is then added to the container, and the cap is installed 80 over the mixing chamber.

The optional mixing nozzle is then added 82 to the mixing nozzle area of the main body. In one embodiment, the optional mixing nozzle is attached with glue to the side of the container. In another embodiment, the optional mixing nozzle is added to the cap. In yet another embodiment, the cap is placed next to the main body, and then the combination of the cap and main body are shrink-wrapped together to form one unit.

The container is then finally packaged 84, such as by placing the hair coloring product in a box, or in another suitable container, such as a hard plastic shell.

### Helical Mixing Embodiment

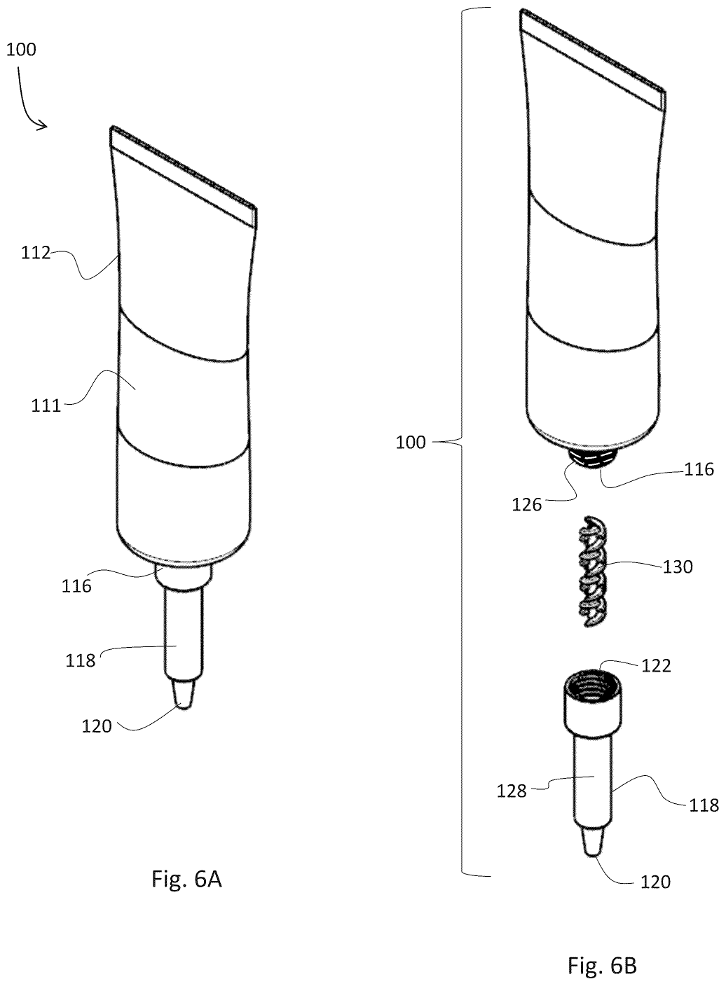

An additional helical embodiment 100 of the invention is depicted in FIG. 6A. The helical embodiment 100 comprises a main body 112 with internal multi-chambers (not shown), as was the case with the prior embodiments. The main body 112 includes a main body tip 116, having ports through which hair coloring substances exit each sub-chamber. The main body tip 116 receives a mixing nozzle 118. The mixing nozzle 118 includes a nozzle tip 120. As described below, a helical mixing tool 130 is within the interior of the mixing nozzle 118 in the space between the main body tip 116 and the nozzle tip 120. The main body 112 may include a label 111, which may include a window into the interior of the main body 112, in one embodiment. The window (now shown) allows the end-user to determine the quantity of hair coloring substances remaining in each sub-chamber of the main body 112.

As can be seen in the exploded view of FIG. 6B, the main body tip 116 includes threads 126 with corresponding threads 122 defined on the interior of the mixing nozzle 118. An elongated portion 128 of the mixing nozzle 118 is substantially hollow and is designed to receive a helical mixing tool 130. The helical mixing tool 130 mixes the hair coloring substances (e.g., colorant and developer) to create a hair coloring solution before the hair coloring solution exits the nozzle tip 120 to be applied to an end user's hair.

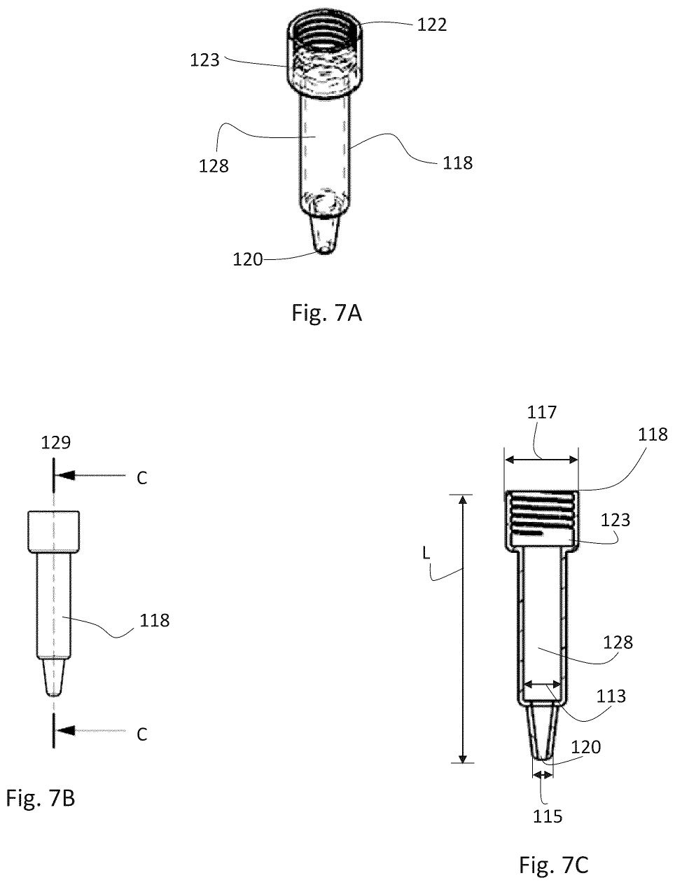

The details of the mixing nozzle 118 are found in FIGS. 7A-7C. The mixing nozzle 118 includes a first area 123, which receives the hair coloring substances from each sub-chamber. The first area 123 includes the threads 122 of the mixing nozzle 118 to secure the mixing nozzle 118 onto the main body 112, as shown in FIG. 6A. The first area 123 is in hair coloring substances communication with the elongated portion 128, which is substantially hollow as it receives the helical mixing tool 130 shown in FIG. 6B. The elongated portion 128 ends in a tapered nozzle tip 120.

As can be appreciated from FIG. 7A, hair coloring substances traverse the mixing nozzle 118 by entering the first area 123, passing through the elongated portion 128, and exiting by the nozzle tip 120.

The mixing nozzle 118 can rotate around a central axis 129, as shown in FIG. 7B. FIG. 7C is a sectional view of the nozzle 118 along line C in FIG. 7B, which again emphasizes the hair coloring substances communication between the first area 123, the elongated portion 128, and the nozzle tip 120. The total length L of the mixing nozzle 118 is 67 mm, in one embodiment. The cross-section 113 of the elongated main portion 128 is 12 mm, in one embodiment. The exterior width 115 of the nozzle tip 120 is 4 mm, in one embodiment. The external width 117 of the first area 123 is 17 mm, in one embodiment. As stated above, other appropriate sizes are also possible.

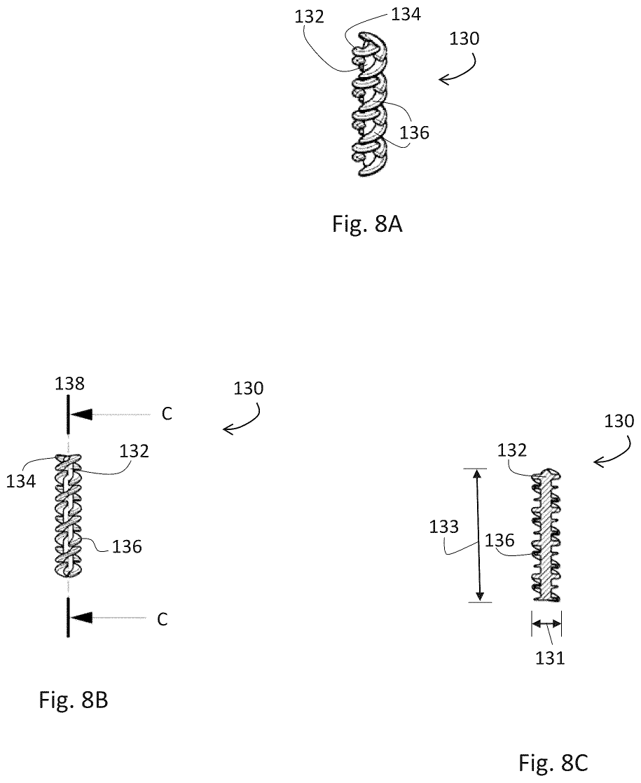

FIGS. 8A-C are detailed views of one embodiment of the helical mixing tool 130. FIG. 8A is an overview of the helical mixing tool 130, designed to fit into the elongated portion 128. The helical mixing tool 130 includes a central pillar 132 and mixing curve structures. The mixing structures are defined on multiple levels around the central pillar 132. The structures include relatively flat structures 134 and looping structures 136, which have a larger surface area and which loop around the central pillar 132. The mixing structures (the flat structures 134, the looping structures 136) are designed to ensure that any substance passing through will not be able to go in a straight line but will have to continue to mix as it passes over the helical mixing tool 130. The looping structures 136 wind or loop around the central pillar 132 without increasing the diameter of the cross-section of the helical mixing tool 130, and so the looping structures 136 create a helical shape to the helical mixing tool 130. In the embodiment shown in the figures, each helical mixing tool includes multiple looping structures 136.

The central axis 138 of the helical mixing tool 130 is shown in FIG. 8B along with the mixing structures (the flat structures 134, the looping structures 136). The cross-section of the helical mixing tool 130 is shown in FIG. 8C, the cross-section having been taken along line C in FIG. 8B. In one embodiment, the helical mixing tool 130 has a cross-section width 131 of approximately 8 mm. The length 133 of the helical mixing tool 130 is approximately 37 mm. As stated above, other appropriate sizes are also possible.

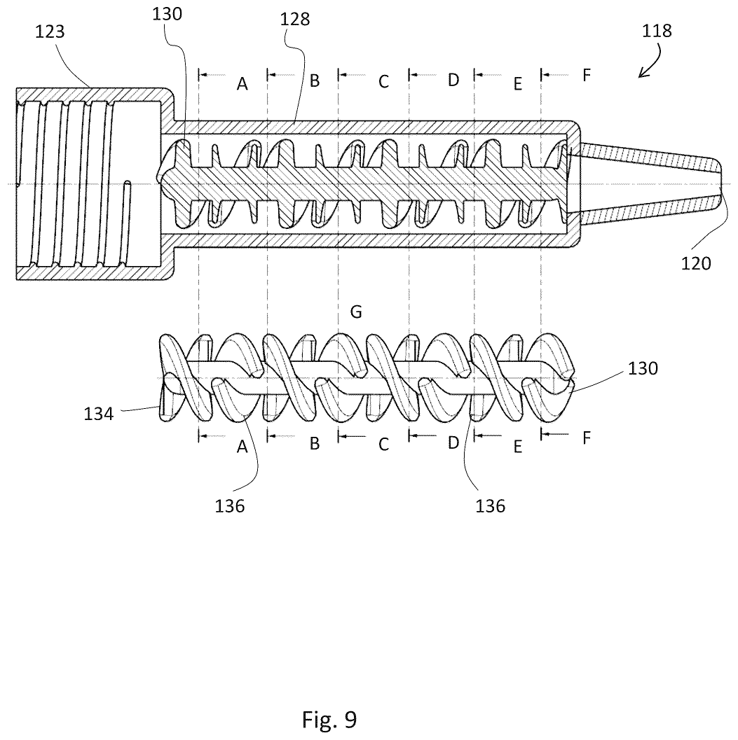

A sectional view of the helical mixing tool 130 installed in the mixing nozzle 118 is shown in FIG. 9. The helical mixing tool 130 is shown concurrently outside of the mixing nozzle 118 to show how the mixing structures (the flat structures 134, the looping structures 136) are arranged.

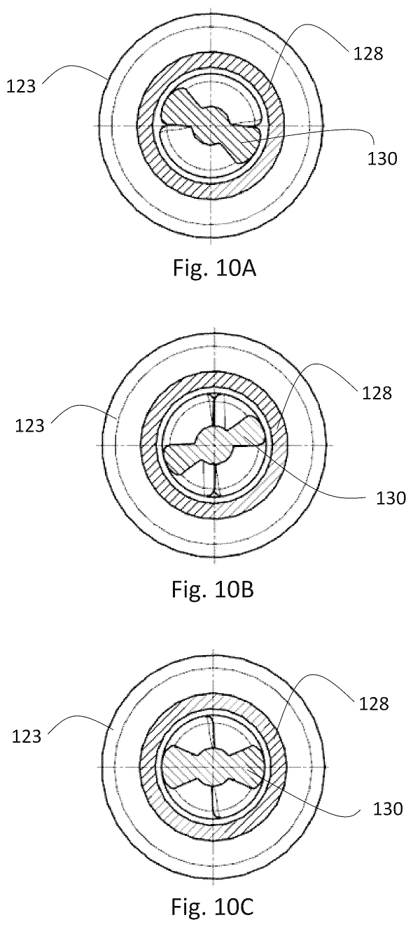

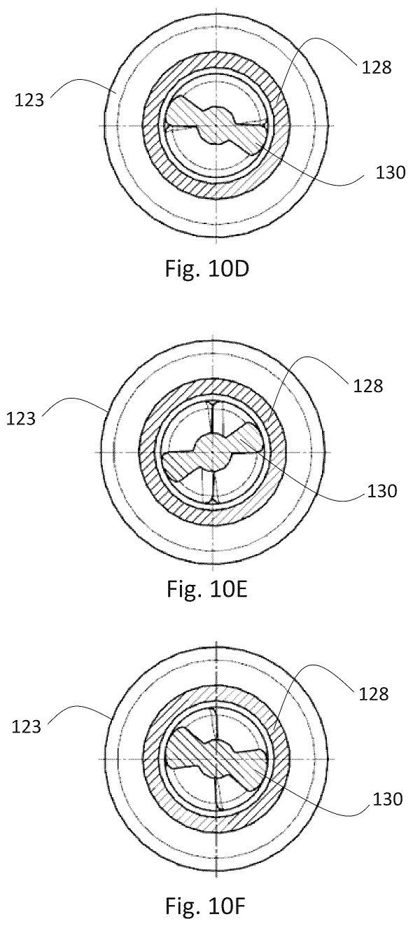

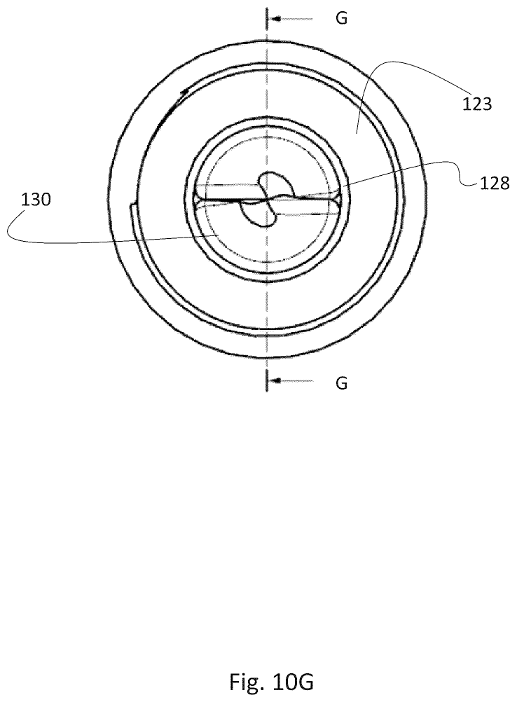

To clarify the operation of the helical mixing tool 130, FIG. 10A shows a cross-section of FIG. 9 along line A. Depicted in FIG. 10A is the cross-section of the helical mixing tool 130, showing a cross-section of the wall of the elongated portion 128 and the first area 123 of the nozzle. The cross-section of the walls of the elongated portion 128 is shown thicker for clarity. In various embodiments, the walls of the elongated portion 128 would be much thinner than the cross-section of the tool 130.

FIG. 10B is a cross-section of FIG. 9 along line B, showing the elongated portion 128, the cross-section of the helical mixing tool 130, and the first area 123 of the mixing nozzle 118. Likewise, FIG. 10C is a cross-section of FIG. 9 along line C, FIG. 10D is a cross-section long line D, FIG. 10E is a cross-section along line E, FIG. 10F is a cross-section along line F.

FIG. 10G is top view showing the axis G in FIG. 9. Depicted in FIG. 10G is the helical mixing tool 130 along with the elongated portion 128 and the first area 123.

As can be appreciated from the views, the helical mixing tool 130 forces the hair coloring substances of the main body 112 to mix in the elongated portion 128 of the mixing nozzle 118. The looping structures 136 are continuously angled and loop around the central pillar 132, except for the flat structures 134. The flow of hair coloring substances is impeded or slowed, but never stopped. As can be appreciated by the cut-away views of FIGS. 10A-F, the helical mixing tool 130 never completely blocks the interior of the elongated portion 128.

As hair coloring substances pass through the elongated portion 128, it will turn the helical mixing tool 130 on its axis, which further encourages additional mixing.

Also possible is any combination of the features of any of the embodiments described above. For example, an embodiment can have a main body 12, 112 with a mixing chamber 36 (either with or without threads) to which a mixing nozzle 50, 118 (or any other mixing nozzle that performs the function of the mixing nozzle 50, 118) can be attached, but it may be without a mixing chamber 36 but instead have a main body tip 116 (either with or without threads 126) to which a mixing nozzle is attached. Also, all of the ports, such as port 40 and port 42 can have the cover 41, or just one port can be with the cover 41. There can be another embodiment where the optional mixing nozzle 50 of FIG. 3 can be used with the main body 112 of FIG. 6A, either with or without a mixing chamber 36. Also possible is an embodiment where its main body 12, 112 has three or more sub-chambers 20, 22. In such embodiment, there is a port 40, 42 for each sub-chamber (e.g., an embodiment with three sub-chambers has three ports, where all or just some ports have the cover 41, or none of the ports has the cover). As explained above, each port may have a different size, but they may also have the same size. The shape of each port may also differ, such as a circular shape, a rhombus shape, a triangular shape, or a rectangular shape. Likewise, the shape and size of any of the components or parts of the embodiments described above can be customized to fit the need of the end-users. These are illustrative examples, and a person of ordinary skill in the art will appreciate that any other combinations and configurations of the above-explained features are also possible.

The embodiments of the hair coloring substances described above include features that a compatible with any number of hair coloring substances but are particularly adapted for the mixing of hair coloring substances. Such hair coloring substances generally have a developer and a colorant that require mixing but should only be mixed prior to use.

Although exemplary implementations of the invention have been depicted and described in detail herein, it will be apparent to those skilled in the relevant art that various modifications, additions, substitutions, and the like can be made without departing from the spirit of the invention. These are therefore considered to be within the scope of the invention as defined in the following claims.

It is to be understood that the above description is intended to be illustrative and not restrictive. For example, the above-described embodiments (and/or aspects thereof) may be used in combination with each other. In addition, many modifications may be made to adapt a particular situation or material to the teachings of the invention without departing from its scope. While the dimensions and types of materials described herein are intended to define the invention parameters, they are by no means limiting but are instead exemplary embodiments. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the terms “comprising” and “wherein.” Moreover, in the following claims, the terms “first,” “second,” and “third” are used merely as labels and are not intended to impose numerical requirements on their objects. Further, the limitations of the following claims are not written in means-plus-function format and are not intended to be interpreted based on 35 U.S.C. § 112, sixth paragraph, unless and until such claim limitations expressly use the phrase “means for” followed by a statement of function void of further structure.

The embodiment of the invention in which an exclusive property or privilege is claimed is defined as follows:

1. A hair color storage device comprising:
at least two sub-chambers, each having an opening to a mixing chamber;
at least one covering of said sub-chambers; and
a removable cap to cover the mixing chamber;
wherein said mixing chamber allows for contents of at least some sub-chambers to interact with at least some remaining sub-chambers.

2. The hair color storage device of claim 1 further comprising a mixing nozzle.

3. The hair color storage device of claim 2, wherein the mixing nozzle comprises interior features to decrease velocity of liquid flow through the nozzle.

4. The hair color storage device of claim 3, wherein said mixing nozzle further comprises a helical mixing tool.

5. The hair color storage device of claim 1, wherein said sub-chambers comprise a pressure-equalizing reversibly deformable material.

6. The hair color storage of claim 1 further comprising a covering substrate for both sub-chambers.

7. The hair color storage device of claim 2, wherein said mixing nozzle is reversibly attached to the mixing chamber.

8. The hair color storage device of claim 1, wherein said cap includes an aperture to receive said mixing chamber.

9. The hair color storage device of claim 2 further comprising a box that receives the storage device and the nozzle.

10. The hair color storage device of claim 2, wherein said nozzle includes reversibly deformable internal structures to decrease velocity of flow of liquid traversing the nozzle.

11. A method of manufacturing a hair color container for a multi-part solution comprising:
providing a first and a second sub-chamber;
filling the first sub-chamber with a first solution;
filling the second sub-chamber with a second solution;
attaching the first sub-chamber to the second sub-chamber;
adding an aperture in each sub-chamber;
covering said apertures;
attaching a mixing chamber to the covered apertures; and
providing a mixing nozzle adapted to be reversibly fastened to the mixing chamber;
wherein each sub-chamber is reversibly deformable and said aperture covering is removable.

12. The method of claim 11 further comprising adding an external covering to the combined two sub-chambers.

13. The method of claim 11 further comprising placing the container in a box.

14. The method of claim 12, wherein said external covering comprises printed indicia.

15. The method of claim 12, wherein said external covering distributes pressure between the sub-chambers.

16. The method of claim 11 further comprising attaching a cap wherein said cap covers said mixing chamber.

17. The method of claim 12 further comprising adding identifying indicia to said external covering.

18. The method of claim 17, wherein said identifying indicia includes a lot number and an expiration date.

19. The method of claim 11, wherein said sub-chambers comprise different volumes of corresponding solutions.

20. The method of claim 12, wherein said external covering comprises a window.
